(19) United States
(12) Patent Application Publication
(10) Pub. No.: US 2007/0050567 A1
(43) Pub. Date: Mar. 1, 2007

(54) Multiple Processor System and Method Establishing Exclusive Control

(76) Inventor: Masahiro Murakami, Kyoto-shi (JP)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/466,809

(22) Filed: Aug. 24, 2006

(30) Foreign Application Priority Data
Aug. 24, 2005 (JP) 2005-242148

(51) Int. Cl. G06F 12/00

(52) U.S. Cl. 711/150

(57) ABSTRACT

A multiple processor system and method is provided. The system comprises a system memory including specific sections; a plurality of processors, each of the processors obtaining a lock before accessing a specific section, and releasing the lock alter accessing the specific section; a processor local bus, connected in common to said system memory and the plurality of processors; a side band bus, connected in common to the plurality of processors; and a lock register, connected to the side band bus for managing the locks.

### BACKGROUND OF THE INVENTION

1. Field of the Invention

The present invention relates to a multiple processor system and a related method enabled to establish exclusive control, and more particularly, to a system and method utilizing a locking technique for establishing access to specific and/or critical sections of a multiple processor system.

2. Description of Background

In a symmetric multiple processor (SMP) system, a plurality of central processing units (CPUs) employ memory in common and share processing tasks equally. Therefore, exclusive control must be exercised in order to maintain the coherency of data. Exclusive control is a process, employed for a multiple processor system, that inhibits the simultaneous access, by a plurality of CPUs, of a resource (a critical section) for which simultaneous accesses should not be permitted.

Generally, a CPU employs a processing sequence to read data from memory, performs an operation using the data, and rewrites the data in memory based on the thus obtained results. Were this processing sequence to be simultaneously performed by a plurality of CPUs for the same data in memory, the correct rewriting of the data would not be possible. Therefore, while a specific CPU is accessing specific data in memory, a lock must be placed on the pertinent data to prevent other CPUs from accessing it. Then, when the processing by the specific CPU has been completed, the pertinent data are unlocked and can be used for processing performed by another CPU. Generally, the term “critical sections” is applied for resources such as data and files, and the right to access a critical section is called a “lock”.

According to this exclusive control method, a CPU must always obtain a lock before being permitted to access a critical section. That is, for a period during which a specific CPU has obtained a lock for and has accessed a critical section, other CPUs can not obtain a lock for that critical section and are prevented from accessing it.

In order to obtain a lock, a CPU must perform a so-called read-modify-write procedure, i.e., the CPU reads a lock bit for desired data, and when a “0” has been written to the bit, which indicates the data are not locked, the CPU writes a “1” to the bit, which indicates the data are locked. However, during a period from the time a specific CPU reads a “0” from a lock bit until it writes a “1” to the bit, if another CPU reads the “0” from the lock bit, this CPU would erroneously determine that a lock could be obtained. In order to prevent this, the above described read-modify-write procedure is atomically (indivisibly) performed.

An SMP compatible processor includes, on a hardware basis, a lock function for guaranteeing the atomic performance of the read-modify-write process, while an SMP incompatible processor does not include such a hardware function.

When an SMP compatible processor and an SMP compatible architecture are employed to provide an SMP system, software can be developed at a low cost; however the hardware becomes expensive. On the other hand, when an SMP incompatible processor and an SMP incompatible architecture are employed, the software development costs become high, while the hardware costs are low. Therefore, there is a demand for an SMP system for which inexpensive hardware can be employed and software development costs can be minimized.

### SUMMARY OF THE INVENTION

A multiple processor system and method is provided. The system comprises a system memory including specific sections; a plurality of processors, each of the processors obtaining a lock before accessing a specific section, and releasing the lock after accessing the specific section; a processor local bus, connected in common to said system memory and the plurality of processors; a side band bus, connected in common to the plurality of processors; and a lock register, connected to the side band bus for managing the locks.

In an alternate embodiment, the lock register includes holding means and locking means. The holding means holds lock information indicating the existence either of a locked state or of an unlocked state. In accordance with a read signal output by each of the processors, the locking means sets, to the locked state, the lock information stored in the holding means.

In this case, when a specific processor outputs a read signal to obtain a lock, lock information is read from the lock register, and immediately, lock information indicating the lock state is written to the lock register. Therefore, the multiple processor system can atomically perform the read-modify-write process to obtain a lock.

In another embodiment, the lock register further includes unlocking means, identification means and switching means. In accordance with a write signal output by each of the processors, the unlocking means sets, in the unlocked state, the lock information stored in the holding means, and the identification means identifies a processor that has obtained a lock. The switching means selects a write signal issued by a processor identified by the identification means, but does not select write signals issued by the other processors.

In this case, since a write signal issued by a processor that has obtained a lock is selected, and a write signal issued by a processor that has not obtained a lock is not selected, only the processor that has obtained the lock can release the lock.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a functional block diagram showing the general configuration of a multiple processor system according to one embodiment of the present invention;

FIG. 2 is a circuit diagram showing the arrangement of a lock register in FIG. 1;

FIG. 3 is a timing chart showing the operation of the lock register in FIG. 2; and

FIG. 4 is a flowchart showing the operation of the multiple processor system in FIG. 1.

### DESCRIPTION OF THE INVENTION

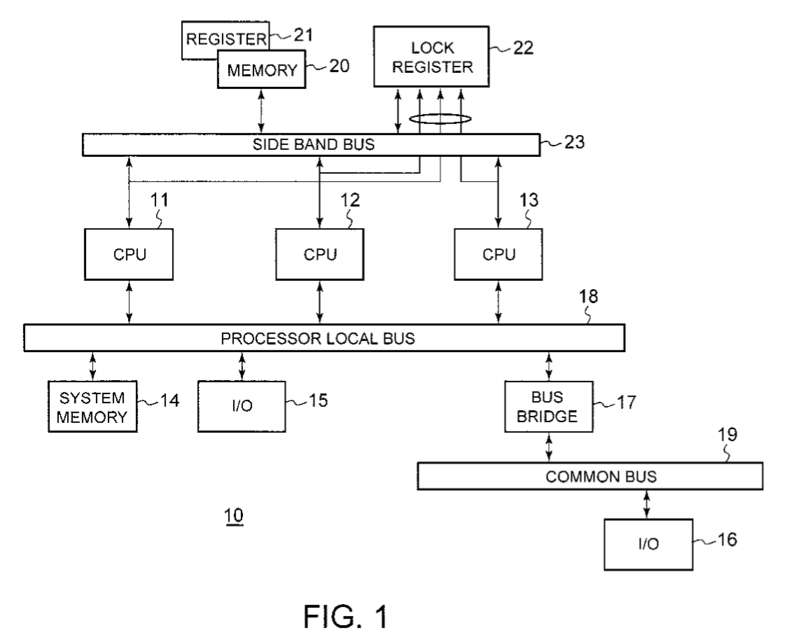

FIG. 1 is an illustration of one embodiment of the present invention depicting a multiple processor system 10. The multiple processor system, in turn comprises, as per example, CPUs 11 to 13, a system memory 14, such as a ROM and a RAM, input/output circuits (I/Os) 15 and 16, a bus bridge 17, a processor local bus 18 and a common bus 19. The CPUs 11 to 13, the system memory 14, the input/output circuit 15 and the bus bridge 17 are connected in common to the processor local bus 18. While the input/output circuit 16 and the bus bridge 17 are connected in common to the common bus 19.

The CPUs 11 to 13 can access the system memory 14 and the input/output circuit 15 via the processor local bus 18. The CPUs 11 to 13 can also access the input/output circuit 16 via the processor local bus 18, the bus bridge 17 and the common bus 19. The system memory 14 forms an address space, as usual, and the CPUs 11 to 13 access this address space. That is, in accordance with a read instruction, the CPUs 11 to 13 read data from a designated address, or in accordance with a write instruction, write data to a designated address. A critical section that the CPUs 11 to 13 should not simultaneously access is present in the system memory 14. In order to access the critical section, exclusive control must be exercised.

The multiple processor system 10 further includes a memory 20, a register 21, a lock register 22 and a side band bus 23. The CPUs 11 to 13, the memory 20, the register 21 and the lock register 22 are connected in common to the side band bus 23. While the CPUs 11 to 13 are also connected directly to the lock register 22.

The memory 20, the register 21 and the lock register 22 form an extended address space that differs from the general address space in the system memory 14, and a special instruction is prepared so that the CPUs 11 to 13 can also access this extended address space. The CPUs 11 to 13 can access the memory 20, the register 21 and the lock register 22 via the side band bus 23, which is a bus, other than the processor local bus 18, that is directly connected to the CPUs 11 to 13 and that includes, for example, a drive control register (DCR) bus. It should be noted that the memory 20 and the register 21 are merely examples, and either only one or neither of them may be provided.

The lock register 22 manages a lock that is required for exclusive control. Before accessing a specific, which can potentially be even a critical section in the system memory 14, each of the CPUs 11 to 13 outputs a read signal and obtains a lock from the lock register 22, and after having accessed the specific or critical section, outputs a write signal and releases the lock.

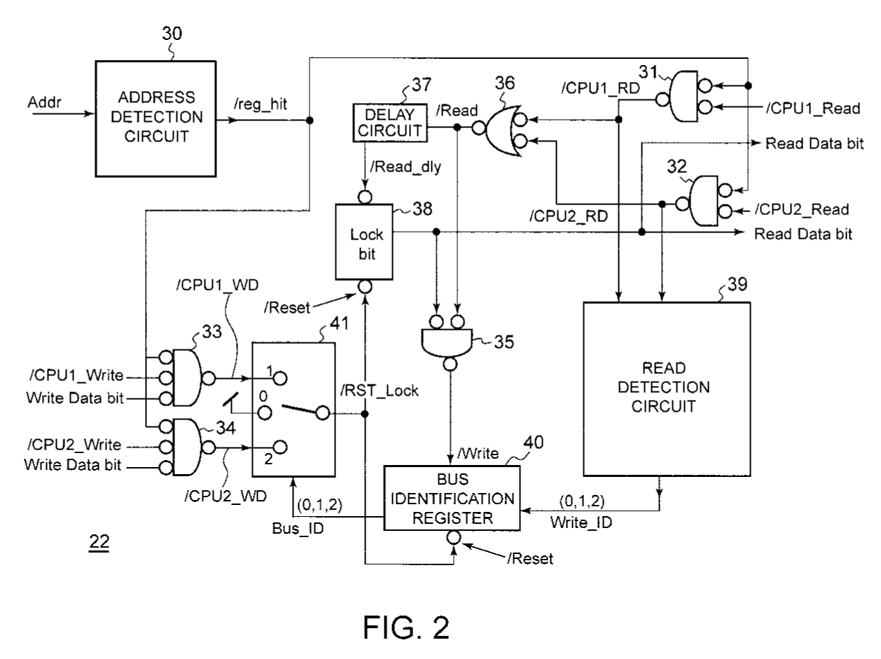

A specific arrangement for the lock register 22 will now be described while referring to FIG. 2. To simplify the explanation, an arrangement for only CPUs 11 and 12 is employed. It should be noted that a / (a slash) provided in front of a signal indicates that the signal is active at a logical low (hereinafter referred to simply as “L”) level.

The lock register 22 includes an address detection circuit 30, AND circuits 31 to 35, an OR circuit 36, a delay circuit 37, an RS flip-flop circuit 38, a read detection circuit 39, a bus identification register 40 and a switching circuit 41.

The address detection circuit 30 selectively renders the lock register 22 active when the circuit 30 detects that address Addr, received from the CPUs 11 and 12, is a predetermined address. Specifically, in accordance with the predetermined address Addr, the address detection circuit 30 sets register hit signal /reg_hit to level L. Then, the lock register 22 accepts read signals /CPU1_Read and /CPU2_Read and write signals /CPU1_Write and /CPU2_Write that are transmitted by the CPUs 11 and 12. The CPU 11 outputs read signal /CPU1_Read to obtain a lock, and when data bit ReadDatabit that is read at this time is “0”, the CPU 11 can obtain a lock, or when data bit ReadDatabit is “1”, the CPU 11 can not obtain a lock. The CPU 12 outputs read signal /CPU2_Read to obtain a lock, and when data bit ReadDatabit that is read at this time is “0”, the CPU 12 can obtain a lock, or when data bit ReadDatabit is “1” the CPU 12 can not obtain a lock. Further, the CPU 11 outputs write signal /CPU1_Write to release a lock, and the CPU 12 outputs write signal /CPU2_Write to release a lock.

In the case of register hit signal /reg_hit at level L, the AND circuit 31 sets read signal /CPU1_RD to level L when read signal /CPU1_IRead, output by the CPU 11, goes to level L. That is, when the CPU 11 is attempting to obtain a lock, read signal /CPU1_RD is rendered active.

In the case of register hit signal /reg_hit at level L, the AND circuit 32 sets read signal /CPU2_RD to level L when read signal /CPU2_Read, output by the CPU 12, goes to level L. That is, when the CPU 12 is attempting to obtain a lock, read signal /CPU2_RD is rendered active.

In the case of register hit signal /reg_hit at level L, the AND circuit 33 sets write signal /CPU1_WLD to level L when write signal /CPU1_Write, output by the CPU 11, goes to level L, and write data bit WriteDatabit becomes “0” (corresponding to level L). That is, when the CPU 11 is attempting to release a lock, write signal /CPU1_WD is rendered active.

In the case of register hit signal /reg_hit at level L, the AND circuit 34 sets write signal /CPU2_WD to level L when write signal /CPU2_Write, output by the CPU 12, goes to level L, and write data bit WriteDatabit becomes “0”. That is, when the CPU 12 is attempting to release a lock, write signal /CPU2_WD is rendered active.

The OR circuit 36 sets read signal /Read to level L when read signal /CPU1_RD or /CPU2_RD goes to level L. The delay circuit 37 delays read signal /Read for a predetermined period of time, and generates a delay read signal /Read_dly. That is, when a predetermined period has elapsed since one of the CPUs tried to obtain a lock, delay read signal /Read_dly is rendered active at level L.

The RS flip-flop circuit 38 holds lock bit Lockbit, and outputs Lockbit as read data bit ReadDatabit. A Lockbit setting of “1” indicates a locked state, and a setting of “0” indicates an unlocked state. When delay read signal /Read_dly goes to level L, the RS flip-flop circuit 38 sets lock bit Lockbit to “1”.

The read detection circuit 39 sets write identification data Write_ID to “1” when read signal /CPU1_RD is at level L or to “2” when read signal /CPU2_RD is at level L, or to “0” in other cases. That is, when the CPU 11 is attempting to obtain a lock, write identification data Write_ID is set to “1”, and when the CPU 12 is attempting to obtain a lock, write identification data Write_ID is set to “2”.

The AND circuit 35 sets write signal /Write to level L when lock bit Lockbit is “0”, and when read signal /Read goes to level L. That is, in a case wherein neither of the CPUs 11 and 12 obtains a lock, when one of them attempts to obtain a lock, write signal /Write is rendered active.

The bus identification register 40 is used to store which of the CPUs has obtained a lock. When write signal /Write is at level L, bus identification data Bus_ID is rewritten in accordance with write identification data Write_ID. Specifically, when write identification data Write_ID is “0”, bus identification data Bus_ID is set to “0”, when write identification data Write_ID is “1”, bus identification data Bus_ID is set to “1”, and when write identification data Write_ID is “2”, bus identification data Bus_ID is set to “2”. Therefore, when neither of the CPUs obtains a lock, and when the CPU 11 is attempting to obtain a lock, the bus identification register 40 stores the acquisition of a lock by the CPU 11. Further, when neither of the CPUs obtains a lock, and when the CPU 12 is attempting to obtain a lock, the bus identification register 40 stores the acquisition of a lock by the CPU 12.

The switching circuit 41 selects a signal at a logical high (hereinafter referred to simply as “H”) level, or write signal /CPU1_WD or /CPU2_WD in accordance with bus identification data Bus_ID, and outputs the selected signal as reset signal /RST_Lock. Specifically, when bus identification data Bus_ID is “0”, lock reset signal /RST_Lock, at level H, is output; when bus identification data Bus_ID is “1”, write signal /CPU1_WD is output as lock reset signal /RST_lock; and when bus identification data Bus_ID is “2”, write signal /CPU2_WD is output as lock reset signal /RST_Lock.

When lock reset signal /RST_Lock goes to level L, the RS flip-flop circuit 38 resets lock bit Lockbit to “0”. Therefore, when the CPU that has obtained a lock is going to release the lock, lock bit Lockbit becomes “0”.

When lock reset signal /RST_Lock goes to level L, the bus identification register 40 resets bus identification data Bus_ID to “0”. Therefore, when a lock is released, data indicating that none of the CPUs has obtained a lock is stored in the bus register 40.

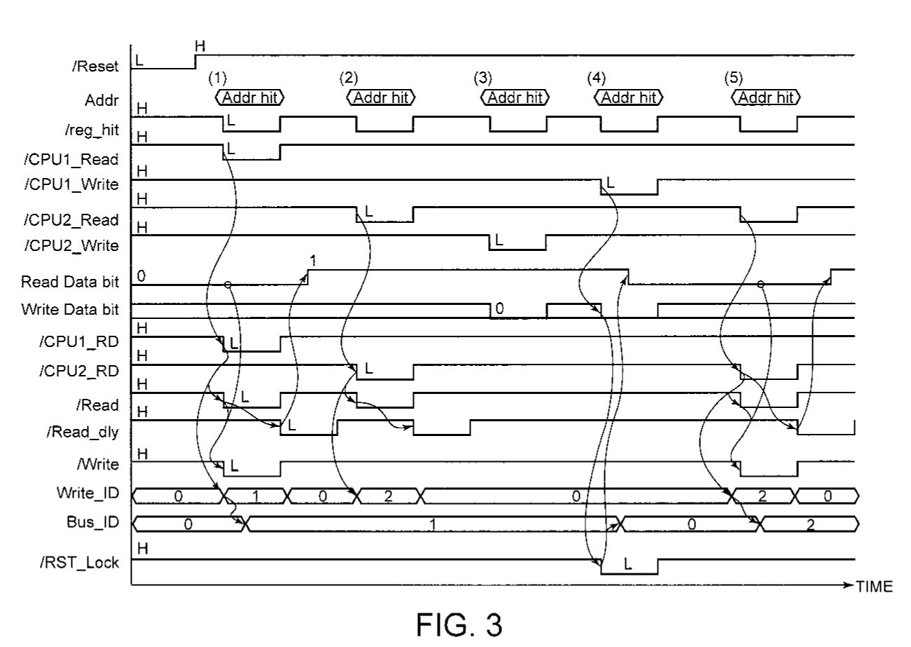

The operation of the lock register 22 will now be described while referring to FIG. 3. Since at first, reset signal /Reset is rendered active at level L, the bus identification register 40 is reset and bus identification data Bus_ID is set to “0”. The RS flip-flop circuit 38 is also reset, and lock bit Lockbit is set to “0”. That is, at first, none of CPUs has obtained a lock.

(1) Acquisition of a lock by the CPU 11 (successful) First, an explanation will be given for a case wherein the CPU 11 attempts to obtain a lock while none of the CPUs has obtained a lock.

When predetermined address Addr is received after reset signal /Reset has been set to level H, the address detection circuit 30 sets register hit signal /reg_hit to level L. During a period in which register hit signal /reg_hit is at level L, the CPU 11 sets read signal /CPU1_Read to level L. At this time, since lock bit Lockbit is set to “0”, and the data bit ReadDatabit is also “0”, the CPU 11 determines that a lock has been obtained. Further, when read signal /CPU1_Read, output by the CPU 11, goes to level L, read signal /CPU1_RD is set to level L by the AND circuit 31 and read signal /Read is set to level L by the OR circuit 36. Furthermore, since read signal /CPU1_RD goes to level L, the read detection circuit 39 sets write identification data Write_ID to “1”. This means that the CPU 11 has attempted to acquire a lock.

At this time, since lock bit Lockbit is “0”, and data bit ReadDatabit is “0”, when read signal /Read goes to level L, accordingly, write signal /Write is also set to level L by the AND circuit 35. Thus, the rewriting of the contents of the bus identification register 40 is enabled, and since write identification data Write_ID is set to “1”, bus identification data Bus_ID is rewritten to “1”. As a result, data indicating that the CPU 11 has obtained a lock is stored in the bus identification register 40.

When a predetermined period has elapsed since read signal /Read went to level L, delay read signal /Read_dly also goes to level L. Thus, the RS flip-flop circuit 38 is reset, and the lock bit Lockbit is set to “1” and is output as the data bit ReadDatabit.

(2) Acquisition of a lock by the CPU 12 (failed) An explanation will now be given for a case wherein the CPU 12 attempts to obtain a lock after one has been obtained by the CPU 11.

During a period in which predetermined address Addr is provided and register hit signal /reg_hit is at level L, when the CPU 12 sets read signal /CPU2_Read to level L, the lock bit Lockbit is set to “1”, as is data bit ReadDatabit. Therefore, the CPU 12 determines that a lock is available for acquisition. Further, when read signal /CPU2_Read, output by the CPU 12, goes to level L, read signal /CPU2_RD is set to level L by the AND circuit 32 and read signal /Read is also set to level L by the OR circuit 36. Furthermore, since read signal /CPU2_RD has gone to level L, the read detection circuit 39 sets write identification data Write_ID to “2”. This means that the CPU 12 has attempted to acquire a lock.

However, at this time, since the setting for the lock bit Lockbit is “1”, the same setting as for the data bit ReadDatabit, write signal /Write remains at level H and does not go to level L, even though read signal /Read does go to level L. Therefore, the rewriting of the contents of the bus identification register 40 is disabled, while write identification data Write_ID is set to “2”, and the setting for bus identification data Bus_ID remains “1” and can not be rewritten. Thus, data indicating that the CPU 11 has obtained a lock continues to be stored in the bus identification register 40. When a predetermined period has elapsed since read signal /Read went to level L, delay read signal /Read_dly also goes to level L. However, since the lock bit Lockbit is already set to “1”, the setting for the data bit ReadDatabit remains “1”.

(3) Release of a lock by the CPU 12 (failed) An explanation will be given for a case wherein the CPU 12 attempts to release a lock after the CPU 11 has obtained the lock.

During a period in which predetermined address Addr is provided and register hit signal /reg_hit is at level L, when write signal /CPU2_Write output by the CPU 12 goes to level L, and when write data bit WriteDatabit is set to “0”, write signal /CPU2_WD is set to level L by the AND circuit 34. However, since the setting for bus identification data Bus_ID is “1” and the switching circuit 41 continues to select write signal /CPU1_WD lock reset signal /RST_Lock is maintained at level H. Thus, the CPU 12 can not release the lock.

(4) Releasing a lock by the CPU 11 (successful) An explanation will now be given for a case wherein the CPU 11 attempts to release a lock it had obtained.

During a period in which predetermined address Addr is provided, and a register hit signal /reg_hit is at level L, when write signal /CPU1_Write, output by the CPU 11, goes to level L, and when write data bit WriteDatabit is set to “0”, write signal /CPU1_WD is set to level L by the AND circuit 33. At this time, since the switching circuit 41 continues to select write signal /CPU I_WD, lock reset signal /RST_Lock also goes to level L. Thus, the RS flip-flop circuit 38 is reset, and lock bit Lockbit is set to “0” and is output as read data bit Read/Databit. Therefore, the CPU 11 can release the lock.

Since the lock reset signal /RST_Lock is set to level L, the bus identification register 40 is also reset and write identification data Write_ID is set to “0”. In accordance with the write identification data Write_ID setting of “0”, the switching circuit 41 selects a signal at level H and lock reset signal /RST_Lock is fixed at level H.

(5) Acquisition of lock by the CPU 12 (successful) An explanation will now be given for a case wherein the CPU 12 attempts to obtain a lock after the CPU 11 has released the lock.

During a period in which predetermined address Addr is provided and register hit signal /reg_hit is at level L, when the CPU 12 sets read signal /CPU2_Read to level L, lock bit Lockbit is set to “0” and the setting for read data bit ReadDatabit is also “0”. Therefore, the CPU 12 determines that acquisition of a lock is enabled. Further, when read signal /CPU2_Read, output by the CPU 12, goes to level L, read signal /CPU2_RD is set to level L by the AND circuit 32 and read signal /Read is also set to level L by the OR circuit 36. Further, since read signal /CPU2_RD goes to level L, the read detection circuit 39 sets write identification data Write_ID to “2”. This means that the CPU 12 has attempted to acquire a lock.

At this time, since lock bit Lockbit is set to “0” and read data bit ReadDatabit is also “0”, when read signal /Read goes to level L, write signal /Write is also set to level L by the AND circuit 35. As a result, the rewriting of the bus identification register 40 is enabled. And since write identification data Write_ID is set to “2”, bus identification data Bus_ID is rewritten to “2”. Through this process, data indicating that the CPU 12 has obtained a lock is stored in the bus identification register 40.

When a predetermined period has elapsed since read signal /Read was set to level L. delay read signal /Read_dly also goes to level L. Then, the RS flip-flop circuit 38 is reset, and lock bit Lockbit is set to “1” and is output as read data bit ReadDatabit.

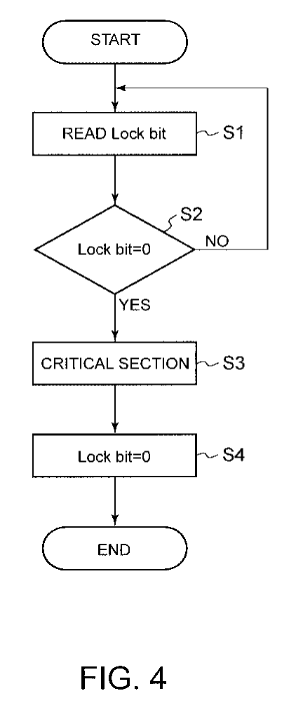

The operation of the entire multiple processor system 10 that employs the lock register 22 will now be explained while referring to FIG. 4.

The CPU 11 or 12 outputs predetermined address Addr, renders read signal /CPU1_Read or /CPU2_Read active at level L, and reads lock bit Lockbit (read data bit ReadDatabit) from the lock register 22 (S1).

The CPU 11 or 12 the determines whether lock bit Lockbit is “0”, i.e., whether data are locked (S2). When lock bit Lockbit=1 and data are locked (No at step S2), the CPU 11 or 12 repeats the reading of the lock bit Lockbit until the lock is released (until Lockbit=0 is established) (S1). This process is called polling the lock bits.

When Lockbit=0 and data are not locked (YES at step S2), the CPU 11 or 12 obtains a lock and accesses a critical section to perform a predetermined process (S3). The predetermined process here includes a process for reading data from the critical section, performing a predetermined operation based on the data and rewriting the data based on the operation results, and the contents of the predetermined process are not especially limited.

After the accessing of the critical section has been completed, the CPU 11 or 12 rewrites lock bit Lockbit to “0” to release the lock (S4).

As described above, according to this embodiment, since the lock register 22 is connected to the side band bus 23 instead of the processor local bus 18, the CPUs 11c to 13 access the lock register 22 via the side band bus 23, rather than via the processor local bus 18, to obtain or release a lock. Therefore, the CPUs 11 to 13 can access the system memory 14 and the input/output circuits 15 and 16 via the processor local bus 18, as usual. And thus, when the CPU 11 or 12 repetitively outputs read signal /CPU1_Read or /CPU2_Read until a lock is obtained, the resulting load is imposed on the processor local bus 18.

Generally, since maintaining the bandwidth is the highest priority for the processor local bus 18, a complicated protocol must be adopted. Consequently, to mount a locking function for the processor local bus 18, a large, expensive circuit is required. On the other hand, compared with the processor local bus 18, only a comparatively simple protocol must be adopted for the side band bus 23, and thus, the hardware configuration that must be provided for the side band bus 23 is simpler than that which must be provided for the processor local bus 18.

Further, when the CPU 11 or 12 outputs read signal /CPU1_Read or /CPU2_Read to obtain a lock, lock bit Lockbit is read from the lock register 22, and immediately, the lock bit Lockbit is set to “1”, to indicate the locked state, and is written to the lock register 22. Thus, when immediately thereafter the CPU 12 or 11 outputs read signal /CPU2_Read or /CPU1_Read, the lock bit Lockbit, set to “1” to indicate the locked state, is read from the lock register 22. And therefore, the CPU 12 or 11 can not obtain a lock. Consequently, a function, the equivalent of a lock bit Lockbit atomic read-modify-write function provided by an expensive multiple processor system, can be obtained simply by employing the lock register 22. As a result, inexpensive hardware can be employed, and development costs for software can be minimized.

The present invention has been explained by employing the embodiment; however, this embodiment is provided merely as an example for carrying out the present invention. Therefore, the present invention is not limited to the above described embodiment, and the above embodiment can be variously modified without departing from the technical scope of the invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A multiple processor system comprising:
a system memory including specific sections;
a plurality of processors, each of the processors obtaining a lock before accessing a specific section, and releasing the lock after accessing the specific section;
a processor local bus, connected in common to said system memory and said plurality of processors;
a side band bus, connected in common to said plurality of processors; and
a lock register, connected to said side band bus for managing the locks.

2. A multiple processor system according to claim 1, wherein said specific sections are sections critical to the operation of said multiple processor system.

3. A multiple processor system according to claim 2, wherein said system also comprises locking and holding means.

4. A multiple processor system according to claim 3, wherein said system also comprises unlocking means operational in conjunction with said locking means.

5. A multiple processor system according to claim 4, wherein said lock register is connected to a side band bus.

6. A multiple processor system according to claim 5, wherein said lock is does not provide access to any processor local bus, so that each processor accesses said lock register via said side band bus when obtaining and/or releasing any lock.

7. A multiple processor system according to claim 6, wherein said holding means is for holding lock information indicating the existence either of a locked state or of an unlocked state.

8. A multiple processor system according to claim 7, wherein said locking means is operating in accordance with a read signal output by each of said processors, setting, in the locked state, the lock information stored in said holding means.

9. A multiple processor system according to claim 8, wherein said locking means is operating in accordance with a read signal output by each of said processors, setting, in the locked state, the lock information stored in said holding means.

10. A multiple processor system according to claim 9, wherein the lock register further includes unlocking means for, in accordance with a write signal output by each of said processors, setting, in the unlocked state, the lock information stored in said holding means.

11. A multiple processor system according to claim 10, wherein the lock register further includes identification means, for identifying a processor that has obtained a lock.

12. A multiple processor system according to claim 11, wherein the lock register further includes switching means, for selecting a write signal issued by a processor identified by said identification means, but not selecting write signals issued by the other processors.

13. A multiple processor system according to claim 3, wherein the lock register further includes:
unlocking means for, in accordance with a write signal output by each of said processors, setting, in the unlocked state, the lock information stored in said holding means;
identification means, for identifying a processor that has obtained a lock; and
switching means, for selecting a write signal issued by a processor identified by said identification means, but not selecting write signals issued by the other processors.

14. In a multiple processor system having a plurality of processors, a method for providing exclusive control to one or more sections of the system comprising: providing a locking system such that each of the processors have to obtaining a lock before accessing a specific section of said system, and releasing the lock after access to said section is completed.

15. A multiple processor method according to claim 14, further providing a holding means for holding lock information indicating the existence either of a locked state or of an unlocked state, in accordance with a read signal

16. A multiple processor method according to claim 14, wherein said locking mechanism is operational in accordance with a read signal output by a specific processor of said plurality of processors, said specific processor reading lock information from said lock register and writing lock information indicating a locked state to said lock register.

17. An exclusive control method, for a multiple processor system that includes a system memory having critical sections, a plurality of processors, a processor local bus connected in common to said system memory and said plurality of processors, a side band bus connected in common to said plurality of processors, and a lock register connected to said side band bus to store lock information indicating either a locked state or an unlocked state, comprising the steps of:
in accordance with a read signal output by a specific processor of said plurality of processors, said specific processor reading lock information from said lock register and writing lock information indicating a locked state to said lock register;
said specific processor accessing a critical section in case that lock information read from said lock register indicates an unlocked state; and
said specific processor accessing the critical section, and thereafter, in accordance with a write signal output by said specific processor, writing to said lock register lock information indicating an unlocked state.

18. An exclusive method according to claim 17, whereby, reading of the lock information is repeated in case that the lock information read from said lock register indicates a locked state.

19. An exclusive method according to claim 18, further comprising a step of: storing a processor that has read, from said lock register, lock information indicating an unlocked state.

20. An exclusive method according to claim 19, wherein said lock register is connected to a side band bus.
